(19) United States
(12) Patent Application Publication
(10) Pub. No.: US 2004/0268312 A1
(43) Pub. Date: Dec. 30, 2004

(54) Application development support, component invocation monitoring, and data processing

(75) Inventors: Mari Abe, Yokohamashi (JP); Masahiro Hori, Nishinomya-shi (JP); Takashi Nerome, Yokohama City (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY

(21) Appl. No.: 10/850,147

(22) Filed: May 20, 2004

(30) Foreign Application Priority Data
May 30, 2003 (JP) 2003-156042

(51) Int. Cl. G06F 9/44

(52) U.S. Cl. 717/124

(57) ABSTRACT

The present invention provides methods, systems and tools for analyzing a consistency and an inconsistency between a JSP page and a component related to the page, and verifying them automatically. In an example embodiment, the present invention includes a monitor for monitoring execution of a component invocation in a web page in which contents are generated dynamically, and extracting information on the component invocation; and a consistency verification unit for verifying the consistency between the component invocation and the component which is a target of it, based on the information on the component invocation extracted by the monitor.

### FIELD OF THE INVENTION

The present invention relates to verifying a consistency between a component invocation of JSP used for a web application and the like, and a component.

### BACKGROUND ART

In the web application for providing services via a network such as the Internet, there is a technology for generating a web page dynamically by means of a script language (server side script language) in a web server, and transmitting it to a client. JSP (Java® Server Pages: a trademark of Sun Microsystems, Inc. in the United States) is one of such kind of server side script languages, and realizes this function by means of Java® (a trademark of Sun Microsystems, Inc. in the United States) language. Specifically, in JSP, a process has been described in an HTML (HyperText Markup Language) file with a script (Java® program), the script is executed in response to a request from the client, and then only a process result is transmitted to the client.

Therefore, in the file of the web page including dynamic contents by means of JSP (hereinafter referred to as JSP page), with respect to the language for representing the above described dynamic contents, many languages exist concurrently such as a description part by JSP or a description part by HTML. The HTML description realizes a layout or a control when the web page is displayed on a browser. On the other hand, the JSP description is the script in which a predetermined process is described, and operates as a servlet on a run time. Then it executes necessary operation with respect to other components accessible according to a design of the above described script, and transmits a result of this operation to the browser as a response.

Here, the component means an object, and the component related to JSP refers to a Java® bean or a message resource, or another JSP page or another web page which the JSP page depends on. FIG. 25 shows a main component group related to the JSP page.

As described above, JSP used for the web application and the like accesses a predetermined component to execute the necessary operation on the run time. However, at an integration test or an operation test in an actual web application development, it is often the case that an inconsistency occurs between a component invocation part of the JSP page and the component developed by another developer, since a specification with respect to description contents of the JSP has not been predefined before the development.

Therefore, conventionally, when the web application is developed, a developer checks a consistency of the description of the JSP page manually, or executes the integration test actually on an application server to detect the inconsistencies one by one, and so on.

However, if there are a vast number of component invocation descriptions in the web application, it is not easy to detect completely the inconsistencies between the component invocations of the JSP page and the components.

If the above described inconsistencies cannot be removed completely, even after the web application is operated, a system failure may occur due to the inconsistency which has existed potentially in the above described web application. Then if the failure occurs, an additional cost will occur on the whole development.

In addition, since a tag description representation created freely by a user is permitted such as a program logic of a Java® scriptlet or a JSP tag library, it has been difficult to analyze the consistency between the JSP page and the component and verify it automatically.

### SUMMARY OF THE INVENTION

Accordingly, in view of the above described problems, it is an aspect of the present invention to provide methods and tools for analyzing the consistency and the inconsistency between the JSP page and the component related to the page, and verifying them automatically.

In addition to the above aspect, it is another aspect of the present invention to support a development task for the JSP page and contribute to improvement of quality of the JSP page and reduction of a development cost by verifying automatically the inconsistency between the JSP page and the component related to the page.

In order to achieve the above described aspects, in an example embodiment, the present invention is realized as a web application development support device configured as will be described below. This web application development support device is characterized by including: a monitor for monitoring execution of a component invocation in a web page in which contents are generated dynamically, and extracting information on the component invocation; and a consistency verification unit for verifying a consistency between the component invocation and the component which is a target of it, based on the information on the component invocation extracted by the monitor.

In another example embodiment, the present invention is realized as a data processing method using a computer. This data processing method comprises: a first step of analyzing, with respect to a component invocation for generating contents in a web page in which the contents are generated dynamically, information on a library to be used for describing the component invocation; a second step of replacing a definition file of the library stored in predetermined storage means, with a library definition file including a function of extracting information on the component invocation on execution of the component invocation, based on a result of the analysis of the first step; and a third step of executing the component invocation by using the library definition file replaced by the second step, and extracting the information on the executed component invocation.

### BRIEF DESCRIPTION OF THE DRAWINGS

These, and further, aspects, advantages, and features of the invention will be more apparent from the following detailed description of a preferred embodiment and the appended drawings wherein:

FIG. 1 shows a configuration of component invocation information defined in this embodiment;

FIG. 2 shows an example of a JSP specification description used in this embodiment;

FIG. 3 shows typically an example of a hardware configuration of a computer for realizing a web application development support device according to this embodiment;

FIG. 4 shows a functional configuration of the web application development support device according to this embodiment;

FIG. 5 illustrates a function of a monitor generation unit in this embodiment;

FIG. 6 is a flowchart illustrating operation of the monitor generation unit in this embodiment;

FIG. 7 is the flowchart illustrating the operation of the monitor generation unit in this embodiment, which is a flowchart illustrating a process of analyzing a tag library for obtaining determination of a class of a component invocation and a related attribute;

FIG. 8 shows information used in the process of FIG. 7, wherein FIG. 8(A) shows a list of paths of a tag library definition file, and FIG. 8(B) shows a definition of a tag handler;

FIG. 9 shows a configuration example of a component class determination table used in this embodiment;

FIG. 10 shows an example of a code of a branch logic in the tag handler added with a logic for the component invocation information;

FIG. 11 shows an example of a source code of a tag handler class having implemented a monitoring function;

FIG. 12 shows an example of the tag library definition file for invoking a monitoring function tag library;

FIG. 13 illustrates a difference between a typical tag handler invocation and an invocation of a monitor, by means of a relationship of the tag library definition file;

FIG. 14 is a flowchart illustrating operation of a request control unit in this embodiment;

FIG. 15 is a flowchart illustrating operation of the monitor in this embodiment;

FIG. 16 illustrates the operation of the monitor with respect to the component invocation;

FIG. 17 shows a configuration of a consistency verification unit in this embodiment;

FIG. 18 is a flowchart illustrating a process flow by an invocation information verification unit in this embodiment;

FIG. 19 is the flowchart illustrating the process flow by the invocation information verification unit in this embodiment;

FIG. 20 is a flowchart illustrating a process of detecting an error item of a lack of description, by the invocation information verification unit in this embodiment;

FIG. 21 shows an example of an invocation result description generated by a result description creation unit of the invocation information verification unit;

FIG. 22 shows a display output example of log information on a verification result by a verification result log output unit of the invocation information verification unit;

FIG. 23 is a flowchart illustrating operation of a specification update unit in this embodiment;

FIG. 24 is a flowchart illustrating an entire flow of a process of verifying a JSP page by the web application development support device of this embodiment; and

FIG. 25 shows a main component group related to the JSP page.

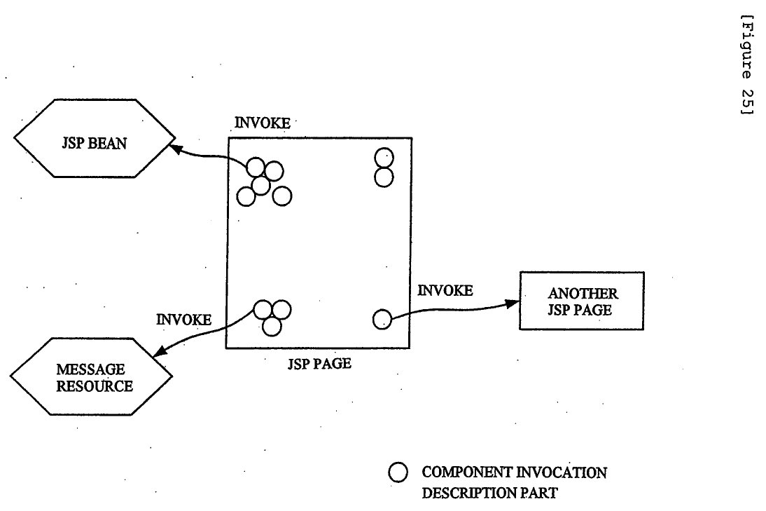

### DESCRIPTION OF THE SYMBOLS

10 . . . Request control unit

20 . . . Monitor

30 . . . Consistency verification unit

31 . . . Invocation information verification unit

32 . . . Result description creation unit

33 . . . Verification result log output unit

34 . . . Specification update unit

40 . . . JSP specification description storage unit

50 . . . Monitor generation unit

101 . . . CPU

103 . . . Main memory

105 . . . Hard disk

### DETAILED DESCRIPTION OF THE INVENTION

The present invention provides methods and tools for analyzing the consistency and the inconsistency between the JSP page and the component related to the page, and verifying them automatically. The present invention supports a development task for the JSP page and contribute to improvement of quality of the JSP page and reduction of a development cost by verifying automatically the inconsistency between the JSP page and the component related to the page.

In an embodiment, the present invention is realized as a web application development support device configured as will be described below. This web application development support device is characterized by including: a monitor for monitoring execution of a component invocation in a web page in which contents are generated dynamically, and extracting information on the component invocation; and a consistency verification unit for verifying a consistency between the component invocation and the component which is a target of it, based on the information on the component invocation extracted by the monitor.

Here, more preferably, if it is not determined until a run time whether a predetermined component invocation is actually executed or not, the monitor extracts the information on the component invocation with or without the execution of the component invocation. In addition, the consistency verification unit verifies the consistency between the component invocation and the component by collating specification information in which the information on the component invocation preset for the web page is packaged, and the information extracted at the monitor.

Furthermore, this web application development support device may be configured to further include a specification update unit for updating the specification information based on a verification result by the consistency verification unit, or a monitor generation unit for generating the monitor corresponding to the component invocation by analyzing information on a library to be used for describing the component invocation.

Moreover, the present invention also may be realized as a component invocation monitoring device configured as will be described below. In other words, this component invocation monitoring device is characterized by including: a request control unit for issuing an HTTP request with respect to a web page in which contents are generated dynamically; and a monitor for monitoring execution of a component invocation for generating the contents in the web page, and extracting information on the component invocation. Furthermore, this component invocation monitoring device may be configured to further include a monitor generation unit for generating the monitor corresponding to the component invocation by analyzing information on a library to be used for describing the component invocation.

Here, more preferably, the monitor generation unit implements the monitor to the device by replacing a definition file of the library stored in predetermined storage means, with a library definition file including a function of extracting the information on the component invocation on the execution of the component invocation, based on a result of analyzing the information on the library.

Moreover, the present invention is also realized as a data processing method using a computer as will be described below. This data processing method is characterized by including: a first step of analyzing, with respect to a component invocation for generating contents in a web page in which the contents are generated dynamically, information on a library to be used for describing the component invocation; a second step of replacing a definition file of the library stored in predetermined storage means, with a library definition file including a function of extracting information on the component invocation on execution of the component invocation, based on a result of the analyzing by the first step; and a third step of executing the component invocation by using the library definition file replaced by the second step, and extracting the information on the executed component invocation.

Moreover, this data processing method may include a fourth step of verifying a consistency between the component invocation and the component which is a target of it, by collating specification information in which the information on the component invocation preset for the web page and stored in the predetermined storage means is packaged, and the information extracted at the third step. Furthermore, the data processing method may also include a fifth step of updating the specification information stored in the predetermined storage means, based on a verification result by the fourth step.

Furthermore, the present invention is also realized as a program for controlling a computer to cause the computer to function as the web application development support device or the component invocation monitoring device as described above, or a program for causing the computer to execute processes corresponding to the respective steps of the above described data processing method. This program may be provided by storing and distributing it in a magnetic disk, an optical disk, a semiconductor memory or other recording media, or by distributing it via a network.

The present invention will be described below in detail based on the embodiment shown in the accompanying drawings. As a method for verifying a developed JSP page, the present invention uses a method for verifying dynamically whether the JSP page to be verified has been developed correctly, by executing a test run of the page. With respect to a JSP description representation, a representation by means of a JSP tag library description is verified. A JSP tag library executes a tag-based description for the description of the JSP page. In this embodiment, with respect to the JSP page to be developed, component invocation information corresponding to a specification for the verification is defined.

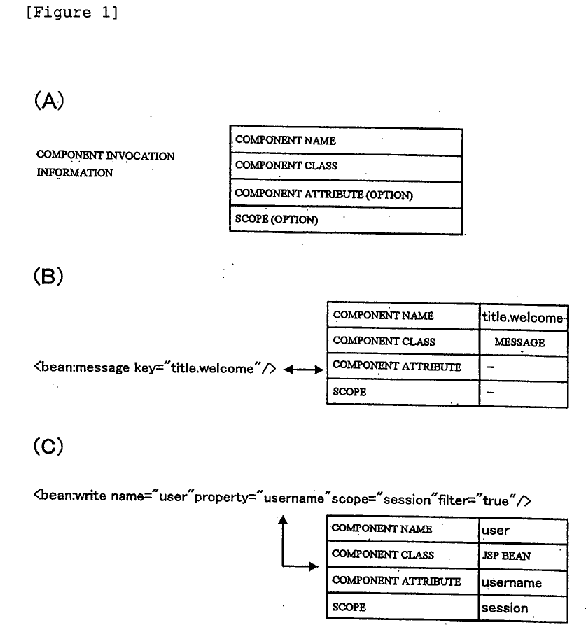

FIG. 1 shows a configuration of the component invocation information defined in this embodiment. As shown in FIG. 1(A), the component invocation information consists of each information on a component name, a component class, a component attribute, a scope, with respect to a component which is a target of the invocation. The component name is a name to be used for executing a component invocation by using attributes of a JSP tag description. The component class is a kind of the component to be invoked, such as a JSP bean, a message resource, another JSP page and the like. The component attribute is information to be used when the attribute is required for the component invocation such as when the component is nested. The scope is information to be used when a session scope, a request scope or the like is designated.

In this embodiment, with respect to the JSP tag description in the JSP page, a component invocation information table as shown in FIG. 1(A) is generated to manage the above described component invocation information. For example, the component invocation information table as shown in FIG. 1(B) is generated with respect to the JSP tag description as follows:

<bean: message key=“title.welcome”/>.

In addition, the component invocation information table as shown in FIG. 1(C) is generated with respect to the JSP tag description as follows:

<bean: write name=“user” property=“username”

scope=“session” filter=“true”/>.

There may be a plurality of JSP tag descriptions in one JSP page. Accordingly, the above described component invocation information is managed collectively in units of JSP pages. A set of the component invocation information table for each JSP page is referred to as a JSP page specification description.

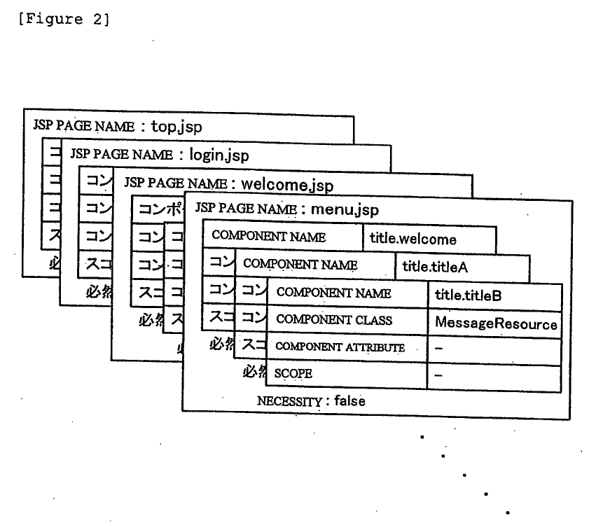

FIG. 2 shows an example of the JSP specification description. As shown in FIG. 2, with respect to each component invocation information on the JSP page, the JSP specification description has information on “necessity” indicating whether the description in the above described JSP page is required or not (which is true if required, or false if not required).

This embodiment verifies a consistency between the JSP page description and the component to be invoked, by means of the component invocation information defined as described above. The above described JSP specification description has been previously created before the verification according to this embodiment is executed. It should be noted that the component invocation information and the JSP specification description only have to include the information which is effective to verify the consistency between the JSP page and the component related to the page, in a certain form, and that they are not limited to the configurations as shown in FIGS. 1 and 2.

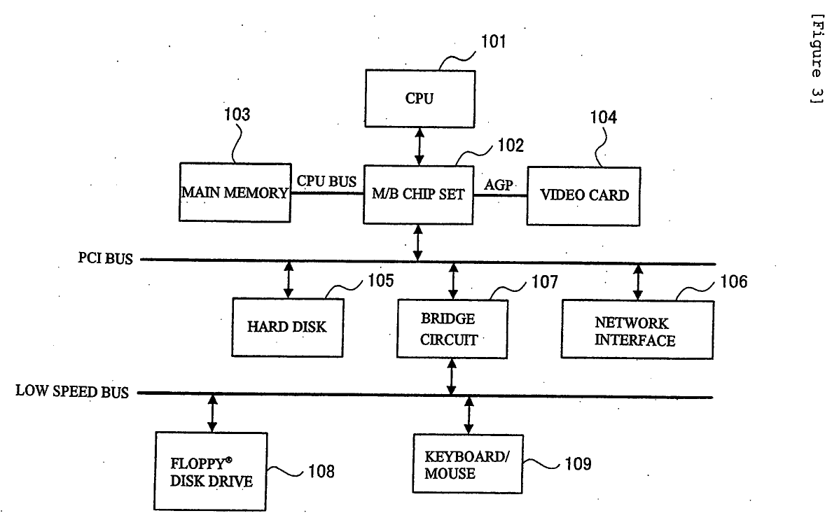

FIG. 3 shows typically an example of a hardware configuration of a computer for realizing a web application development support device according to this embodiment. The computer shown in FIG. 3 is provided with a CPU (Central Processing Unit) 101 as arithmetic means, a main memory 103 connected to the CPU 101 via a M/B (Motherboard) chip set 102 and a CPU bus, a video card 104 also connected to the CPU 101 via the M/B chip set 102 and an AGP (Accelerated Graphics Port), a hard disk 105 connected to the M/B chip set 102 via a PCI (Peripheral Component Interconnect) bus, a network interface 106, and a floppy disk drive 108 and a keyboard/mouse 109 connected to the M/B chip set 102 via a bridge circuit 107 and a low speed bus such as an ISA (Industry Standard Architecture) bus from the PCI bus.

It should be noted that FIG. 3 only illustrates the hardware configuration of the computer for realizing this embodiment, and it is possible to take other various configurations if this embodiment is applicable to them. For example, instead of providing the video card 104, only a video memory may be mounted to have a configuration for processing image data in the CPU 101, and as an external storage device, a drive for a CD-R (Compact Disc Recordable) or a DVD-RAM (Digital Versatile Disc Random Access Memory) may be provided via an interface such as an ATA (AT Attachment) or a SCSI (Small Computer System Interface).

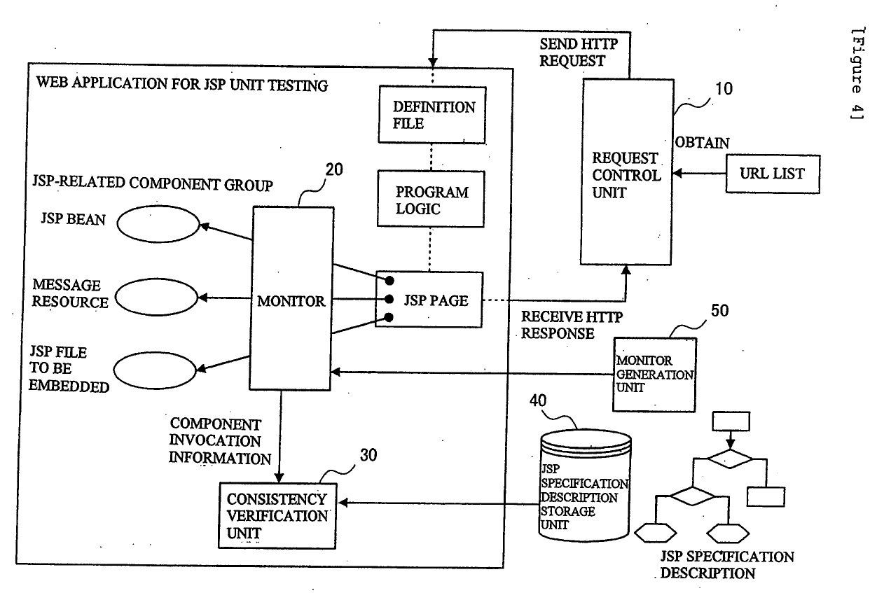

FIG. 4 shows a functional configuration of the web application development support device according to this embodiment. With reference to FIG. 4, the web application development support device of this embodiment is provided with a request control unit 10 for issuing an HTTP (HyperText Transfer Protocol) request to execute the test run of the JSP page, a monitor 20 for monitoring the component invocation by the executed JSP page, a consistency verification unit 30 for verifying the consistency between the JSP page description and the component to be invoked, based on a monitoring result by the monitor 20, a JSP specification description storage unit 40 having stored the JSP specification description of the JSP page to be verified, and a monitor generation unit 50 for generating the monitor 20.

The request control unit 10, the monitor 20, the consistency verification unit 30 and the monitor generation unit 50 shown in FIG. 4 are software blocks to be realized, for example, in the program-controlled CPU 101 in FIG. 3. A program for controlling the CPU 101 to realize these functions may be provided by storing and distributing it in a magnetic disk, an optical disk, a semiconductor memory or other recording media, or by distributing it via a network. In addition, the JSP specification description storage unit 40 is realized, for example, in the main memory 103 or the hard disk 105 in FIG. 3. In this embodiment, a web application for JSP unit testing for executing the test run of the JSP page to be verified is provided, and the JSP page is executed in response to the HTTP request from the request control unit 10. Then as shown in FIG. 4, among the above described components, the monitor 20 and the consistency verification unit 30 are realized as functions of the web application for JSP unit testing, for executing the test run of the JSP page to be verified.

In this embodiment, the representation by means of the JSP tag library description is verified. Though there is a JSP tag library opened to the public as a library, it is also possible to develop it freely by a user. Therefore, in order to extract invocations with respect to all JSP tag libraries, it is required to generate the monitor 20 which may monitor the component invocation with respect to unaccommodated JSP tag libraries. In this embodiment, the monitor generation unit 50 is provided to generate automatically the necessary monitor 20 prior to the verification of the JSP.

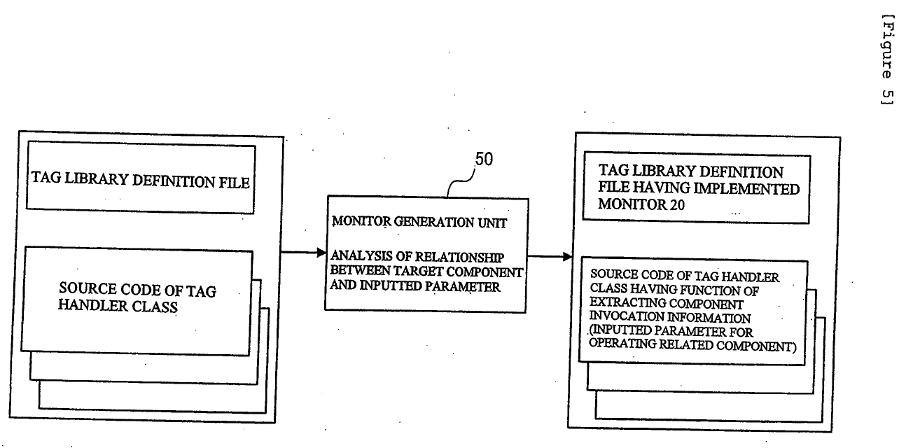

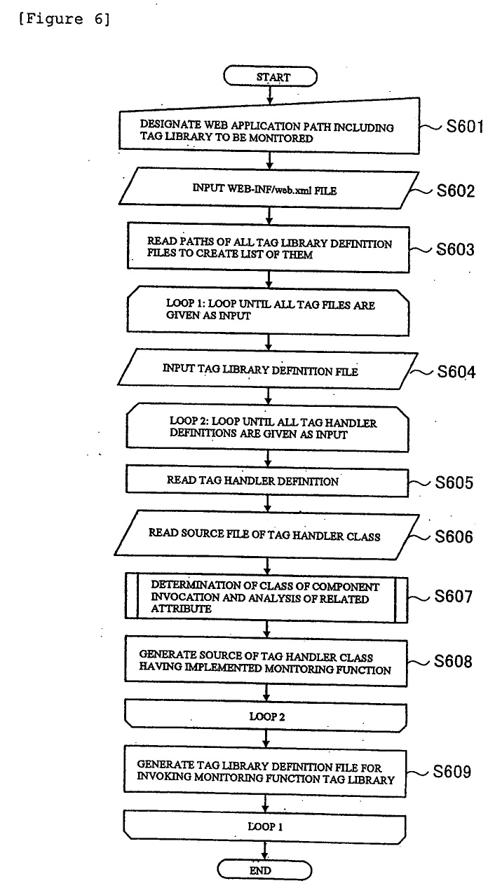

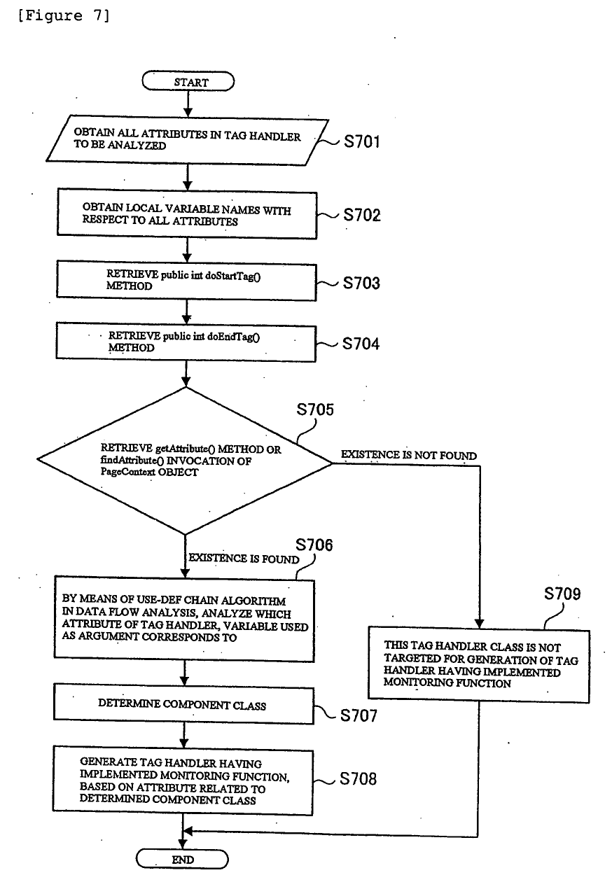

FIG. 5 illustrates a function of the monitor generation unit 50, and FIGS. 6 and 7 are flowcharts illustrating operation of the monitor generation unit 50. With reference to FIG. 5, the monitor generation unit 50 inputs JSP tag library related resources, that is, a tag library definition file and a source code of a tag handler class, from predetermined storage means (for example, the main memory 103 or the hard disk 105 in FIG. 3), and analyzes the component which is the target of the invocation, and an inputted parameter. Then the monitor generation unit 50 outputs resources related to the monitor 20, that is, the tag library definition file having implemented the monitor 20 and the source code of the tag handler class having a function of extracting the inputted parameter for operating the related component. In other words, the JSP tag library related resources used for the description of the component invocation in the JSP page are replaced with the JSP tag library related resources including a function of the monitor 20 for extracting the information on the component invocation when the above described component invocation is executed.

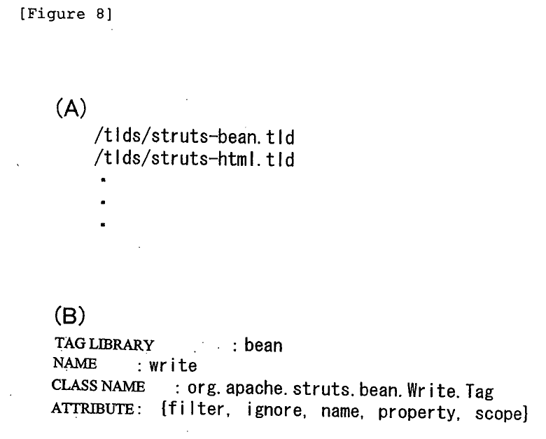

With reference to FIG. 6, a process of analyzing the tag library by the monitor generation unit 50 for obtaining determination of a class of the component invocation and the related attribute will be described below. As shown in FIG. 6, the monitor generation unit 50 first designates a web application path including the tag library to be monitored by the monitor 20 (step 601). Then the monitor generation unit 50 inputs a WEB-INF/web.xml file from the designated web application path (step 602), and reads paths of all the tag library definition files to create a list of them (step 603). An example of the created list of the paths is shown in FIG. 8(A).

Next, the monitor generation unit 50 inputs a predetermined tag library definition file (step 604), and reads a predetermined tag handler definition in the inputted tag library definition file (step 605). An example of the read tag handler definition is shown in FIG. 8(B).

Next, the monitor generation unit 50 reads a source file of the above described tag handler class from the tag library definition file inputted at step 604 (step 606). Then the monitor generation unit 50 executes the analysis process for the determination of the class of the component invocation and the related attribute (step 607). This process will be described below with reference to FIG. 7.

After the analysis process at step 607, the monitor generation unit 50 generates the source file of the tag handler class having implemented a monitoring function, based on a result of the above described process (step 608). The processes of the above described steps 605 to 608 are executed with respect to all the tag handler definitions included in the tag library definition file inputted at step 604 (loop 2).

Next, the monitor generation unit 50 generates the tag library definition file for invoking a monitoring function tag library, based on the tag library definition file in which the above described processes have been executed with respect to all the tag handler definitions (step 609). The processes of the above described steps 604 to 609 are executed with respect to all the tag library definition files included in the list created at step 603 (loop 1).

Next, with reference to FIG. 7, the analysis of the source code of the tag handler class of the JSP at step 607 will be described below. In this analysis process, it is analyzed which attribute is related to the component invocation, based on the attribute obtained from the tag library definition file. The monitor generation unit 50 first obtains all attributes in a tag handler to be analyzed (step 701). In the example shown in FIG. 8(B), the attributes {filter, ignore, name, property, scope} are obtained.

Next, the monitor generation unit 50 obtains local variable names with respect to all the attributes obtained at step 701 (step 702). The local variable name is typically identical to an attribute name. If the local variable name and the attribute name are not identical, the local variable name may be estimated from a getter method.

Next, the monitor generation unit 50 retrieves a public int doStartTag( ) method based on the obtained local variable name (step 703), and furthermore retrieves a public int doEndTag( ) method (step 704).

Typically in the JSP, component operations existing in various scopes are executed by invoking a getAttribute (name, pageContext.APPLICATION_SCOPE,) method and a pageContext.findAttribute (name) method as methods of a PageContext object. Thereby the monitor generation unit 50 next retrieves these method invocations. Then if these method invocations do not exist, the above described tag handler class is not targeted for the generation of the tag handler class having implemented the monitoring function, and the analysis process is completed (steps 705 and 709).

On the other hand, if the method invocations for the get Attribute (name, pageContext.APPLICATION_SCOPE,) method and the pageContext.findAttribute (name) method exist in the tag handler, the monitor generation unit 50 next uses a USE-DEF chain algorithm in a data flow analysis to analyze which attribute of the tag handler the variable corresponds to, which is used as an argument for a name variable part which is the argument of the method, by means of a definition reference relationship of the variable representing the attribute (steps 705 and 706). If a predetermined attribute may be derived, it is possible to find a possibility to access the component, for example, by using a value of the above described attribute of the JSP tag description.

Next, the monitor generation unit 50 determines the component class (step 707). The determination of the component class is determined depending on which type the object as a returned value of the above described method has. Association of the type of the object as the returned value and the component class is represented with a component class determination table.

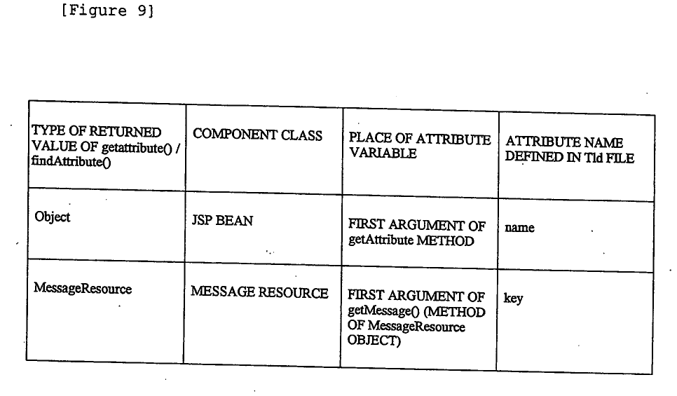

FIG. 9 shows a configuration example of the component class determination table. In the component class determination table shown in FIG. 9, the types of returned values of the getAttribute( )/findattribute( ), the component class, a place of an attribute variable and the attribute name defined in a Tld file are associated with one another. In the example shown in FIG. 9, for example, if the type of the returned value of the method is the type of the message resource, the component is determined as a message component. To cite specific examples, in the case of the following description, the component class is determined as the JSP bean:

Object object=pageContext.findAttribute(name);

In addition, in the case of the following description, the component class is determined as the message resource:

MessageResources resource=

(MessageResources)pageContext.getAttribute(bundle,

pageContext.APPLICATION_SCOPE);

String messageValue=resource.getMessage(key);

It should be noted that the association of the type of the object and the component class shown in the component class determination table is determined depending on the JSP tag library to be targeted. Therefore, the relationship of this association needs to be given prior to the execution of the analysis process.

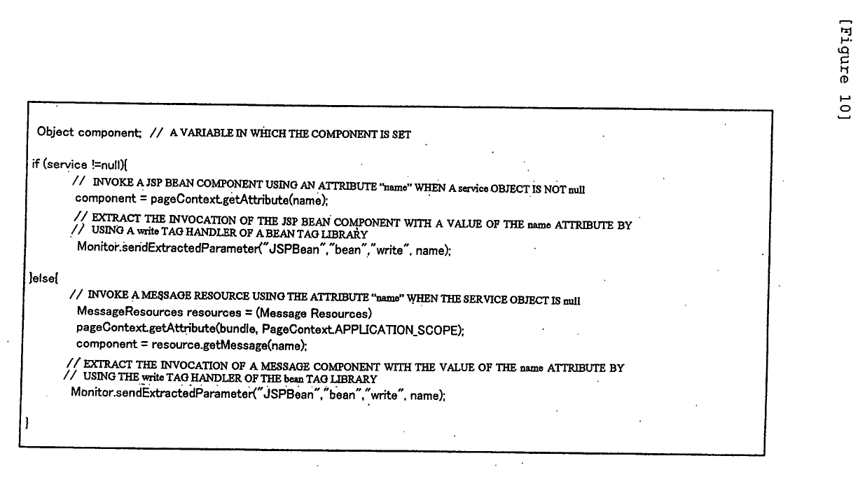

Moreover, in the tag handler, there may be a branch logic which may not be analyzed with respect to whether the component invocation is actually executed. In this case, it may not be determined whether the component is actually invoked, without executing the above described tag handler. Therefore, a logic for extracting the component invocation information has been added just after a component invocation part. Thereby when the tag handler is executed, it is possible to communicate the invoked component invocation information. FIG. 10 shows an example of the logic for the component invocation information, added in the code of the branch logic in the tag handler.

After the above described analysis, the monitor generation unit 50 generates the tag handler having implemented the monitoring function, based on the attribute name obtained in this analysis and the component class (step 708). Then as described above, the source file of the class is generated from the tag handler resulted from this analysis, and the tag library definition file for invoking the monitoring function tag library is generated (see steps 608 and 609 in FIG. 6).

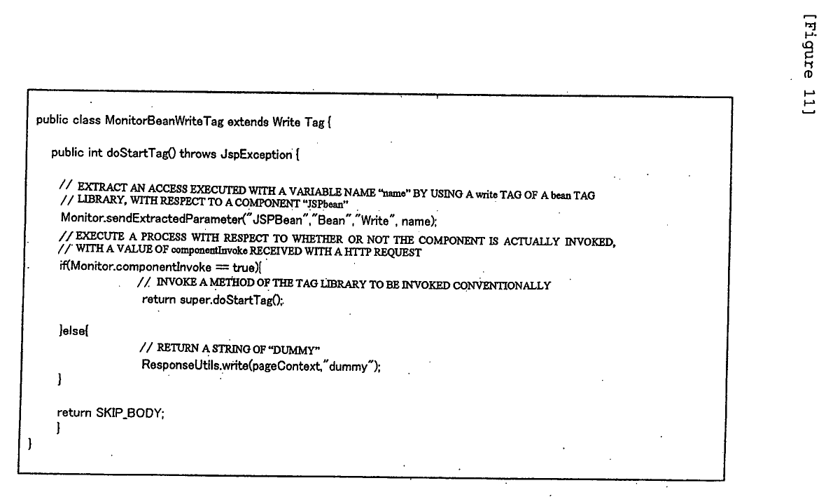

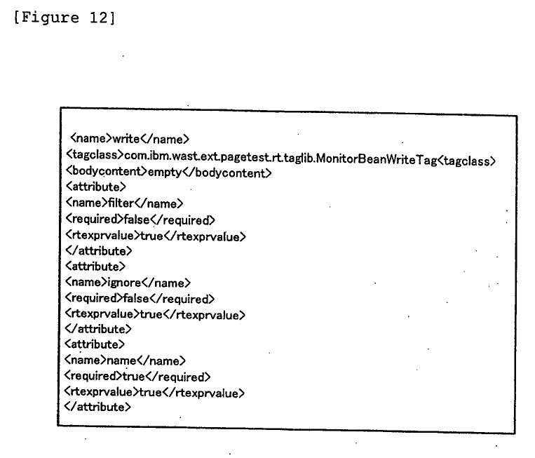

FIG. 11 shows an example of the source code of the tag handler class having implemented the monitoring function, and FIG. 12 shows an example of the tag library definition file for invoking the monitoring function tag library.

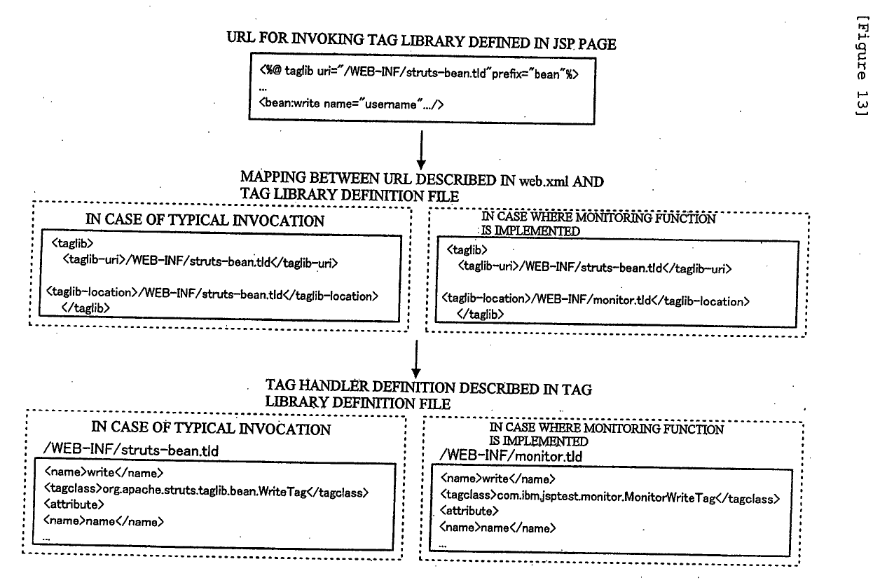

FIG. 13 illustrates a difference between a typical tag handler invocation and the invocation of the monitor 20 by means of a relationship of the tag library definition file. In an example of FIG. 13, when a mapping between a URL described in the web.xml (web application) and the tag library definition file is executed from the description:

<bean:write name=“username” . . . /> of the URL for invoking the tag library declared in the JSP page, in case of a typical invocation, “struts-bean.tld” is invoked from the description of a taglib by:

/WEB-INF/struts-bean.tld

and “WriteTag” is invoked from the tag handler definition described in the tag library definition file.

On the other hand, after the monitoring function has been implemented, when the mapping between the URL described in the web.xml and the tag library definition file is executed, “monitor.tld” is invoked from the description of the taglib by:

/WEB-INF/monitor.tld

and “MonitorWriteTag” will be invoked from the tag handler definition described in the tag library definition file.

As described above, the function of the monitor 20 will be invoked by changing an operating environment of the web application (the tag library definition file and the web.xml), without changing the description of the JSP page at all.

Though the monitor generation unit 50 associates the attribute received from the tag handler with the component invocation in order to generate the monitor 20, there are the cases where it may not be ensured that the component invocation itself is executed certainly in the above described typical analysis. These cases will be summarized below.

1. When an occurrence of the component invocation class is determined by the branch logic.

The tag handler class may describe the branch logic as the logic of Java® on various conditions. For example, it is possible to invoke the component with a date or a time, or invoke the component with a behavior of the object accompanied with a business logic. In addition, in the tag library of a framework “Struts,” if the component does not exist in the session scope, there is a logic for fetching the component as the message resource. In this logic, the component class to be obtained varies depending on whether it is the case where the component of the session scope is fetched or the case where the component is fetched from the message resource.

For such determination by the logic, it is necessary to execute the logic on a test application in which the resource which can perform the branch logic is prepared individually for each test environment.

2. When the tag handler is used in which the operation with respect to the PageContext object could not be detected.

In the tag handler, there is the case where the attribute value is not used for the operation of the PageContext object, or the case where the description of the PageContext object may not be analyzed. Though it is often the case that such a tag handler does not execute the component invocation, the tag handler may be affected by the component invocation of a nested tag handler. For example, with respect to the tag library of the Struts, there is a “logic” tag handler, and there is the case where the invocation of the nested tag handler is not executed, depending on the attribute value of the JSP tag description using the “logic”.

In the above described two cases, even if the “necessity” is true with respect to the component invocation information in the JSP specification description, a static analysis may not ensure that the invocation is executed certainly when the above described JSP page is executed. Therefore, it is necessary to execute the component invocation by executing the above described JSP page dynamically.

With the function of the monitor generation unit 50 as described above, as shown in FIG. 4, the necessary monitor 20 is implemented to the web application for JSP unit testing. As described above, the generation of the monitor 20 by the monitor generation unit 50 is executed prior to the verification of the JSP page. The verification of the JSP page itself is executed in the request control unit 10, the generated monitor 20 and the consistency verification unit 30. In addition, in order to verify the JSP page, the JSP specification description as shown in FIG. 2 has been previously created with respect to the JSP page to be verified, and stored in the JSP specification description storage unit 40.

The request control unit 10 obtains a URL (Uniform Resource Locators) list for executing the JSP page, adds a parameter “componentInvoke=true” and transmits it to the web application for JSP unit testing. The URL list, in which URLs of a JSP page group to be tested are collected, is previously prepared by a developer of the JSP page (web application). Moreover, it is also possible to generate the URL list automatically by using a tool, with which a set of the JSP pages may be edited, to select the JSP page group to be verified.

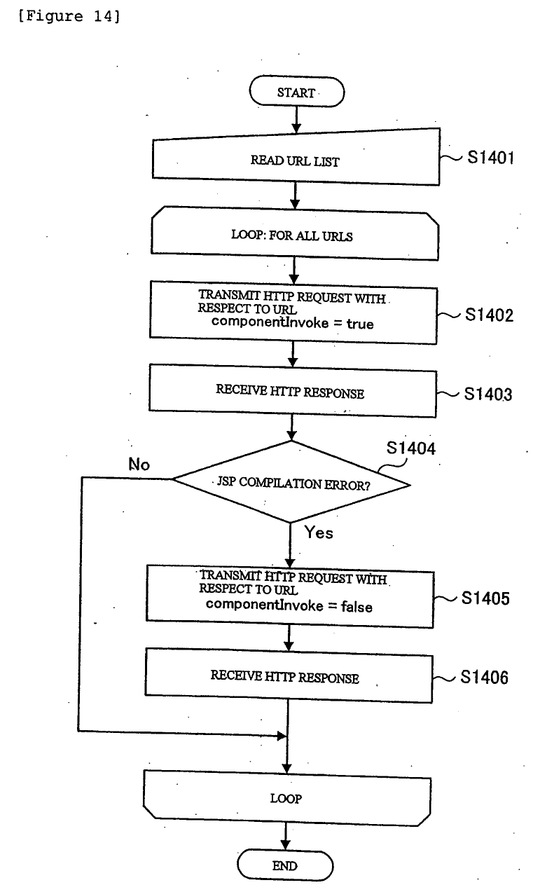

FIG. 14 is a flowchart illustrating operation of the request control unit 10. With reference to FIG. 14, the request control unit 10 reads the URL list prepared as described above (step 1401), and transmits the HTTP request with respect to a predetermined URL in the above described URL list (step 1402). Then, the parameter “componentInvoke=true” is added to this HTTP request. When the request control unit 10 receives an HTTP response which is a response with respect to this HTTP request, it examines whether a JSP compilation error occurs in the above described HTTP response (steps 1403 and 1404). If the JSP compilation error does not occur, the process with respect to the above described URL is completed.

On the other hand, as a result of the HTTP request by means of this URL list, if the JSP compilation error occurs and an error result is returned as the HTTP response, the request control unit 10 adds a parameter “componentInvoke=false” to the HTTP request and transmits the HTTP request again (step 1405). In the JSP compilation error, it is highly likely that an inconsistency has occurred in an association of the JSP tag description and the component. Thereby, by transmitting the HTTP request again, the request control unit 10 does not execute the component invocation but causes the web application for JSP unit testing to execute a dummy run giving a dummy result to the invocation part, and receives the HTTP response (step 1406). The dummy run will be described below. Steps 1402 to 1406 are executed with respect to all the URLs in the URL list read at step 1401 (loop).

In the web application for JSP unit testing, the JSP page developed by the developer and the component which may be executed in the test are provided, and the JSP page corresponding to the HTTP request issued from the request control unit 10 may be invoked via an HTTP servlet by means of the tag library definition file and a program logic. Moreover, the monitor 20 generated by the monitor generation unit 50 and the consistency verification unit 30 for verifying the consistency between the JSP page and the component are implemented to the web application for JSP unit testing. In addition, as shown in FIG. 13, in the JSP tag description of the JSP page, the JSP tag handler invocation is replaced with the invocation to the monitor 20.

The monitor 20 is invoked together with the test run of the JSP page, and monitors the component invocation by the above described JSP.

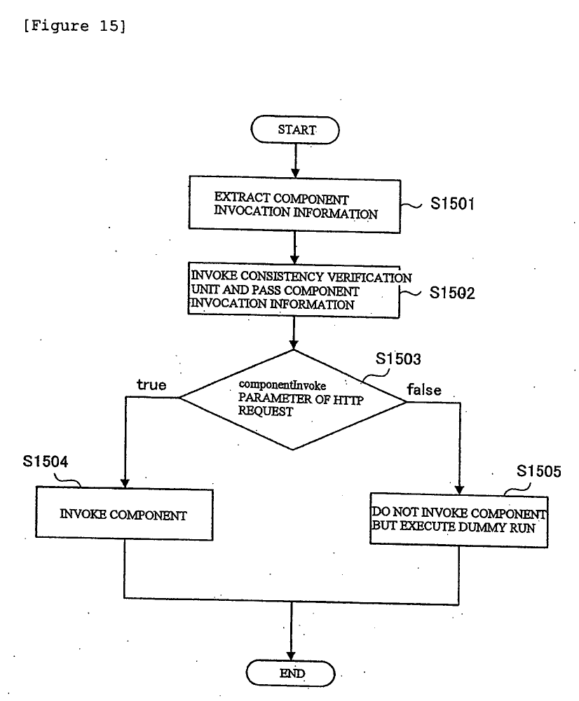

FIG. 15 is a flowchart illustrating operation of the monitor 20. With reference to FIG. 15, the monitor 20 first extracts the component invocation information in the JSP page which is a target of the HTTP request (step 1501). Then the monitor 20 invokes the consistency verification unit 30, and passes the component invocation information extracted at step 1501, together with a JSP page name which may be obtained from an HTTP request name, to the consistency verification unit 30 (step 1502).

Next, the monitor 20 refers to the parameter “componentInvoke” in the HTTP request from the request control unit 10 (step 1503), and when the value of the parameter is true, the monitor 20 executes the component invocation actually with respect to the JSP tag handler in the original JSP tag description (the tag handler before it is replaced with the invocation to the monitor 20) (step 1504). Then the monitor 20 transmits the component invocation information in the above described component invocation to the consistency verification unit 30. In addition, the monitor 20 returns the result of the component invocation to the JSP page as will be described below.

On the other hand, when the value of the parameter “componentInvoke” is false, the monitor 20 does not execute the component invocation but executes the dummy run, and returns the dummy result to the JSP page as the result of the component invocation (step 1505). In this case, as an actual process result in the JSP tag description part, a string of “dummy” is returned. In addition, if a branch process which may not be determined without executing the tag handler actually is related to the component invocation, only the invocation information is extracted with respect to all the components by the logic added just after the component invocation part at the monitor generation unit 50, and transmitted to the consistency verification unit 30.

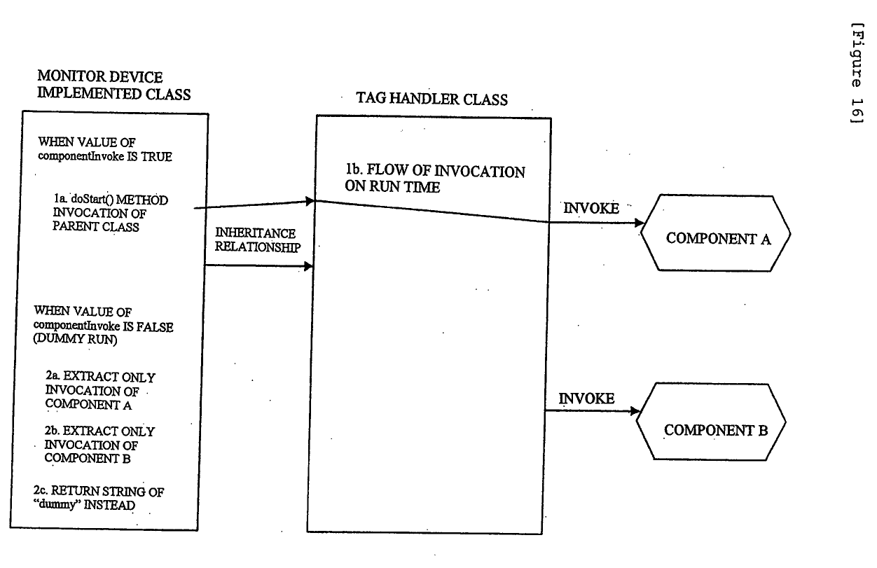

FIG. 16 illustrates the operation of the monitor 20 with respect to the component invocation. In an example of this figure, components A and B are to be invoked. In FIG. 16, when a class to which the monitor 20 has been implemented together with the execution of the JSP page (hereinafter, referred to as monitor implemented class) is invoked, if the value of componentInvoke is true, the monitor implemented class returns a doStart( ) method invocation of a parent class to the tag handler class. Then by the operation of the method invocation at the run time of the tag handler class, the corresponding components A and B are invoked. On the other hand, if the value of componentInvoke is false, the invocation of the components A and B is not executed but only the component invocation information is extracted, and the monitor implemented class returns the string of “dummy,” instead of the method invocation, to the tag handler class.

Based on the component invocation information obtained by the above described monitor 20, the consistency verification unit 30 verifies the consistency between the above described component invocation and the component.

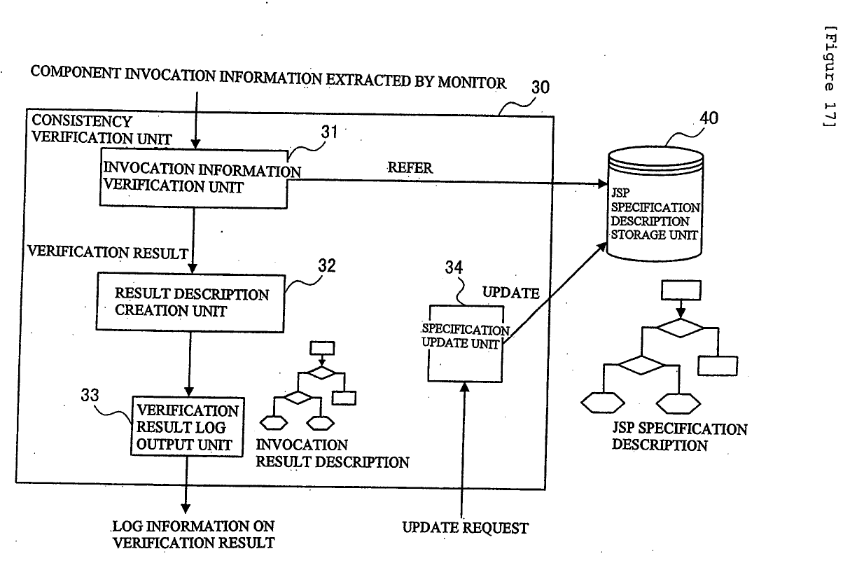

FIG. 17 shows a configuration of the consistency verification unit 30. With reference to FIG. 17, the consistency verification unit 30 is provided with an invocation information verification unit 31 for verifying the component invocation information, a result description creation unit 32 for creating a verification result of the component invocation in the JSP page in a predetermined description form, a verification result log output unit 33 for outputting a log of the verification result created at the result description creation unit 32, and a specification update unit 34 for updating the JSP page specification description if necessary.

The invocation information verification unit 31 inputs the component invocation information extracted by the monitor 20, refers and compares the above described JSP page specification description stored in the JSP specification description storage unit 40 to verify the consistency.

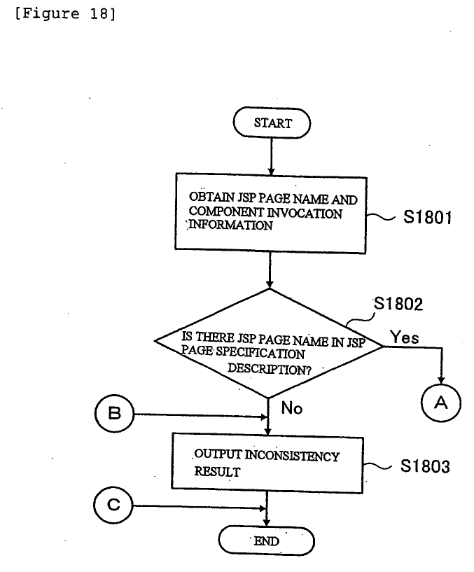

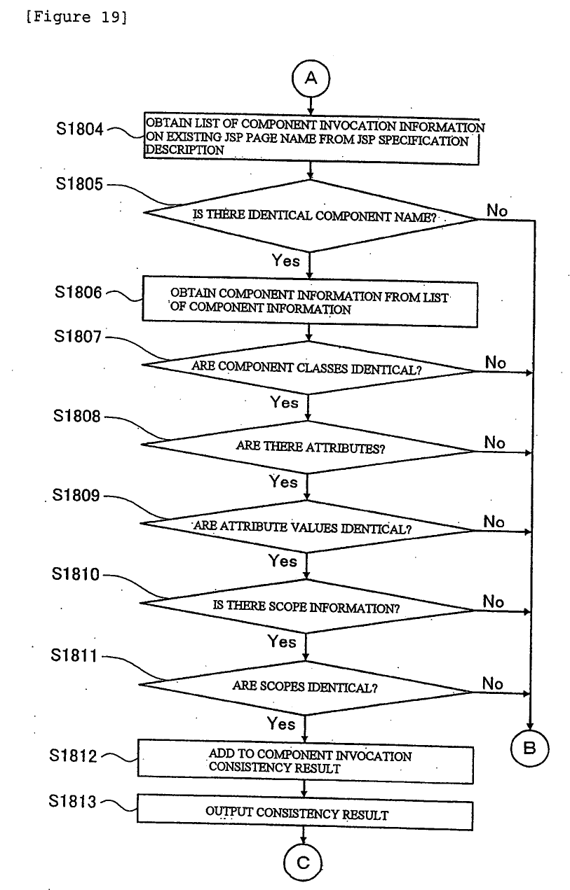

FIGS. 18 and 19 are flowcharts illustrating a process flow by the invocation information verification unit 31. As shown in FIG. 18, when the invocation information verification unit 31 obtains the JSP page name and the component invocation information extracted by the monitor 20 from the JSP page of which the test run has been executed (step 1801), it first examines the JSP specification description storage unit 40 and examines whether there is the JSP specification description corresponding to the obtained JSP name (step 1802). If there is not the corresponding JSP specification description, since the component invocation in the above described JSP page and the component which is the target of the invocation are inconsistent, the invocation information verification unit 31 informs the result description creation unit 32 of the verification result as the inconsistency (step 1803).

If the JSP specification description corresponding to the obtained JSP name is stored in the JSP specification description storage unit 40, the invocation information verification unit 31 next obtains the list of the component invocation information (component names) registered in the above described JSP specification description (step 1804 in FIG. 19). Then the invocation information verification unit 31 examines whether there is the component name of the component invocation information extracted by the monitor 20, in the above described list (step 1805). If there is not the identical component name, since the component invocation in the above described JSP page and the component which is the target of the invocation are inconsistent, the invocation information verification unit 31 informs the result description creation unit 32 of the verification result as the inconsistency (step 1803).

If there is the component invocation information in the JSP specification description having the identical component name as the component invocation information extracted by the monitor 20, the invocation information verification unit 31 next obtains the above described component invocation information in the above described JSP specification description, from the JSP specification description storage unit 40 (step 1806). Then with respect to the obtained component invocation information and the component invocation information extracted by the monitor 20, the invocation information verification unit 31 examines whether the component classes are identical (step 1807), and if the component attributes are described, whether these attribute values are identical (steps 1808 and 1809), and if the information on the scopes is described, whether these scopes are identical (steps 1810 and 1811), respectively. If any of the component classes, the attribute values and the scopes are different, since the component invocation in the above described JSP page and the component which is the target of the invocation are inconsistent, the invocation information verification unit 31 informs the result description creation unit 32 of the verification result as the inconsistency (step 1803).

On the other hand, if all of the component classes, and the attribute values or the scopes in the case where the attributes or the scope information are described, are identical, the invocation information verification unit 31 registers the above described component invocation to a list for extracting a lack of description as will be described below (step 1812). Then, the invocation information verification unit 31 informs the result description creation unit 32 of the verification result as the consistency (step 1813).

In addition, the invocation information verification unit 31 checks an error item of the lack of description, when the extraction of the component invocation is completed for each JSP page in the monitor 20.

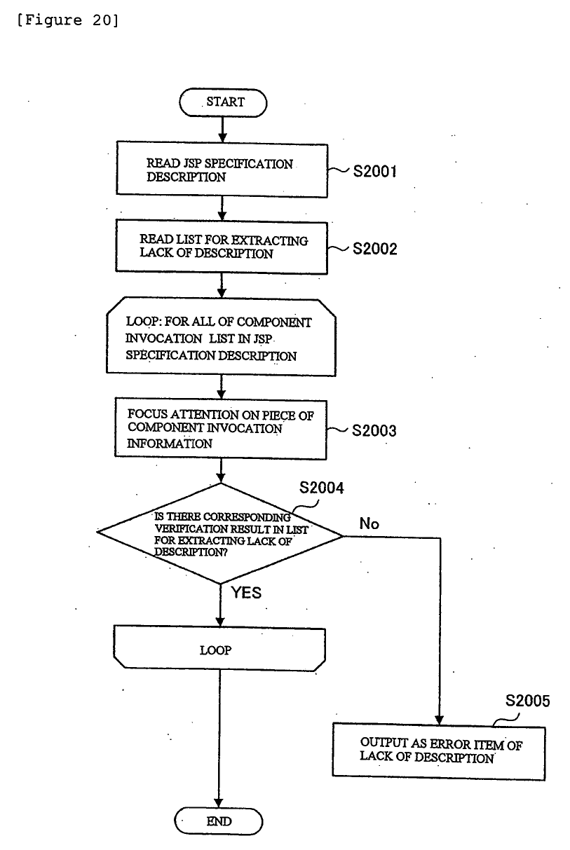

FIG. 20 is a flowchart illustrating a process of detecting the error item of the lack of description, by the invocation information verification unit 31. With reference to FIG. 20, the invocation information verification unit 31 first reads the JSP specification description from the JSP specification description storage unit 40, and reads the list for extracting the lack of description created at step 1812 in FIG. 19 (steps 2001 and 2002). Then the invocation information verification unit 31 focuses attention on each component invocation information in the JSP specification description in the JSP page to be verified (that is, corresponding to the list), sequentially (step 2003), and examines whether there is the verification result corresponding to the above described component invocation information in the list for extracting the lack of description (step 2004).

The processes of the steps 2003 and 2004 are executed with respect to all the component invocation information in the JSP specification description in the JSP page to be verified (loop). Then if there is even just one component invocation information which does not exist in the list for extracting the lack of description, at the moment, the invocation information verification unit 31 informs the result description creation unit 32 that the error of the lack of description has occurred in the above described JSP page to be verified, and completes the process (step 2005).

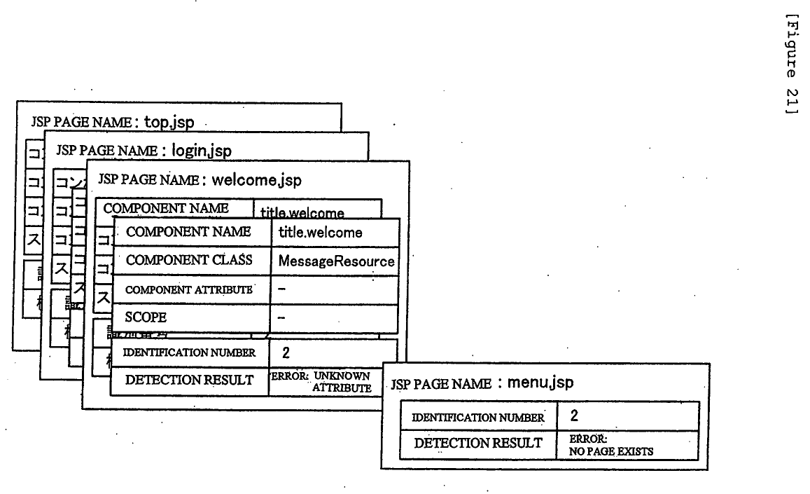

The result description creation unit 32 creates an invocation result description based on the verification result at the invocation information verification unit 31. The invocation result description in which the component invocation information obtained as a result of the verification is collected in units of JSP pages, includes the information on whether there is the consistency or the inconsistency, a reason for the inconsistency (no JSP page exists, the attribute is unknown, and the like), the lack of description and the like. FIG. 21 shows an example of the invocation result description. In the example shown in FIG. 21, in the invocation result description, the component invocation information extracted at the monitor 20 and the verification result by the invocation information verification unit 31 are described. In addition, an identification number with respect to this verification result is added to the invocation result description.

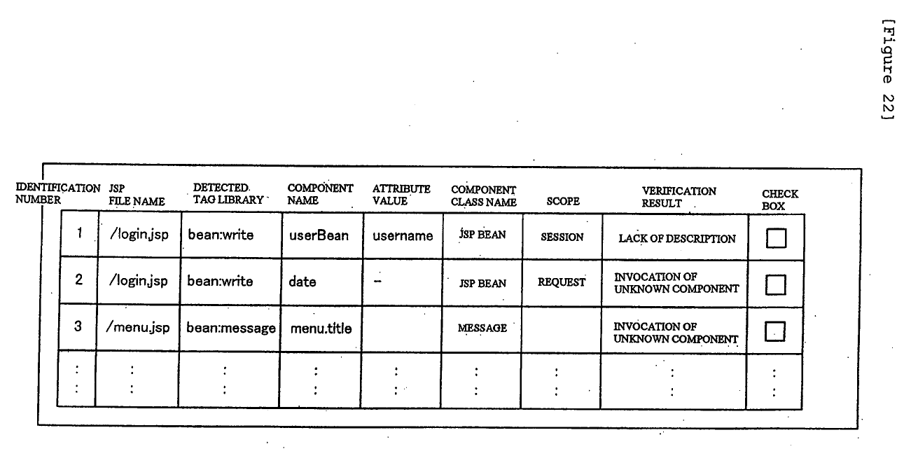

The verification result log output unit 33 outputs log information on the verification result based on the invocation result description created by the result description creation unit 32, displays the above described log information on a predetermined display device for example, and informs the developer of the JSP page (web application) of it. FIG. 22 shows a display output example of the log information on the verification result. In FIG. 22, a rightmost check box is used for designating which JSP page (JSP file) to update, in a specification update process as will be described below.

The developer can check the outputted verification result to modify the JSP tag description of the JSP page with respect to an inconsistent part, based on the above described verification result. Furthermore, in this embodiment, it is possible to reflect the inconsistent part obtained from the verification result, on the JSP page specification description as a correct JSP tag description. In this case, the developer designates the identification number of the verification result and the necessity information (true or false) on the inconsistent JSP page, and requests the specification update unit 34 to update the JSP specification description. The specification update unit 34 accepts the above described update request and updates the JSP specification description of the JSP page which is the target of the above described request.

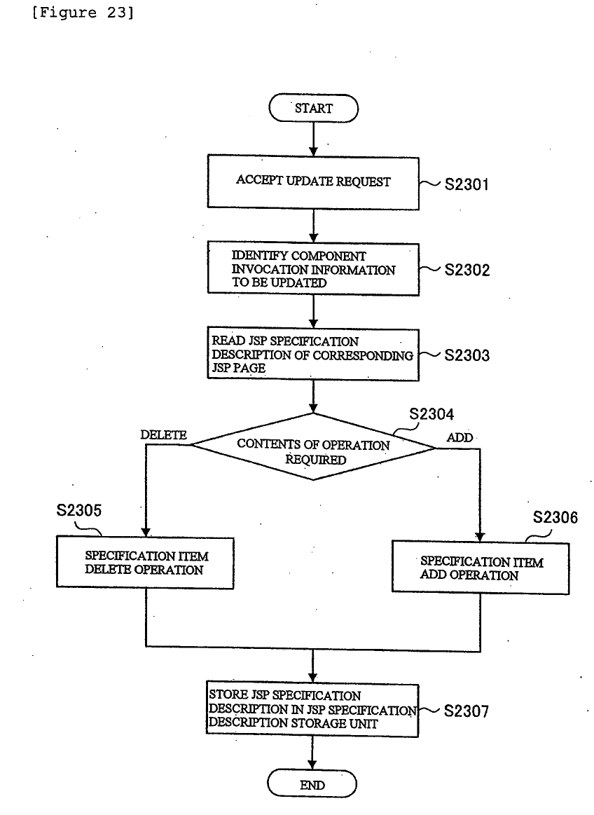

FIG. 23 is a flowchart illustrating operation of the specification update unit 34. With reference to FIG. 23, when the specification update unit 34 accepts the update request (step 2301), it identifies the component invocation information to be updated, based on the identification number included in the above described update request (step 2302). Then the specification update unit 34 reads the JSP specification description of the corresponding JSP page from the JSP specification description storage unit 40 (step 2303).

Next, the specification update unit 34 deletes or adds the description of a desired item in the JSP specification description, depending on contents of the update request (steps 2304, 2305 and 2306). Then the specification update unit 34 stores the JSP specification description in which description contents have been changed, in the JSP specification description storage unit 40 (step 2307). As described above, the contents of the component invocation information extracted by the monitor 20 will be reflected on the JSP specification description of the corresponding JSP page.

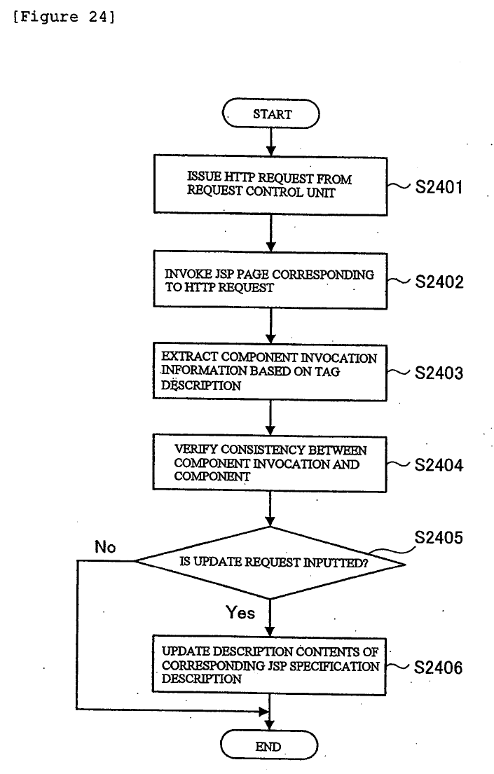

Next, a process of verifying the JSP page by the web application development support device of this embodiment, which is configured as described above, will be described below. FIG. 24 is a flowchart illustrating an entire flow of the process of verifying the JSP page by the web application development support device of this embodiment. As shown in FIG. 24, the request control unit 10 first issues the HTTP request by means of the URL previously prepared (step 2401). This HTTP request is processed by the tag library definition file and the program logic in the web application for JSP unit testing, and the JSP page corresponding to the HTTP request is invoked (step 2402). Then the contents generated dynamically by this JSP page are returned to the request control unit 10 as the HTTP response.

On the other hand, when the JSP page is invoked, the monitor 20 extracts the component invocation information with respect to the component invocation to be executed by the tag handler, based on the tag description of the above described JSP page (step 2403). Then, the consistency verification unit 30 collates the extracted component invocation information with the JSP specification description preset and stored in the JSP specification description storage unit 40, and verifies the consistency between the above described component invocation and the component which is the target of it (step 2404).

The developer of the JSP page (web application) refers this verification result, and as a measure for accommodating it, the developer may choose to modify the inconsistent part of the JSP page to be verified, or to update the JSP specification description. If the developer updates the JSP specification description, on condition that the update request is inputted, the specification update unit 34 of the consistency verification unit 30 updates the description contents of the JSP specification description into the contents of the component invocation information extracted at the monitor 20 (steps 2405 and 2406).

As described above, according to the present invention, it is possible to analyze the consistency and the inconsistency between the JSP page and the component related to the page, and verify them automatically. In addition, according to the present invention, it is possible to support a development task for the JSP page and contribute to improvement of quality of the JSP page and reduction of a development cost by verifying the consistency and the inconsistency between the JSP page and the component related to the page.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1) A web application development support device, comprising:
a monitor for monitoring execution of a component invocation for generating contents in a web page in which said contents are generated dynamically, and extracting information on said component invocation; and
a consistency verification unit for verifying a consistency between said component invocation and the component which is a target of said component invocation, based on the information on said component invocation extracted by said monitor.

2) The web application development support device according to claim 1, wherein if it is not determined until a run time whether a predetermined component invocation is actually executed or not, said monitor extracts the information on said component invocation with or without the execution of said component invocation.

3) The web application development support device according to claim 1, wherein said consistency verification unit verifies the consistency between said component invocation and said component by collating specification information in which the information on said component invocation preset for said web page is packaged, and the information extracted at said monitor.

4) The web application development support device according to claim 1, further comprising a specification update unit for updating said specification information based on a verification result by said consistency verification unit.

5) The web application development support device according to claim 1, further comprising a monitor generation unit for generating said monitor corresponding to said component invocation by analyzing information on a library to be used for describing said component invocation.

6) A component invocation monitoring device, comprising:
a request control unit for issuing an HTTP request with respect to a web page in which contents are generated dynamically; and
a monitor for monitoring execution of a component invocation for generating said contents in said web page, and extracting information on said component invocation.

7) The component invocation monitoring device according to claim 6, further comprising a monitor generation unit for generating said monitor corresponding to said component invocation by analyzing information on a library to be used for describing said component invocation.

8) The component invocation monitoring device according to claim 7, wherein said monitor generation unit implements said monitor to the device by replacing a definition file of said library stored in predetermined storage means, with a library definition file including a function of extracting the information on said component invocation on the execution of said component invocation, based on a result of analyzing the information on said library.

9) A data processing method for using a computer to execute a predetermined data process, comprising:
a first step of analyzing, with respect to a component invocation for generating contents in a web page in which said contents are generated dynamically, information on a library to be used for describing said component invocation;
a second step of replacing a definition file of said library stored in predetermined storage means, with a library definition file including a function of extracting information on said component invocation on execution of said component invocation, based on a result of the analyzing; and
a third step of executing said component invocation by using said replaced library definition file, and extracting the information on said executed component invocation.

10) The data processing method according to claim 9, further comprising a fourth step of verifying a consistency between said component invocation and the component which is a target of said component invocation, by collating specification information in which the information on said component invocation preset for said web page and stored in the predetermined storage means is packaged, and the information extracted at said third step.

11) The data processing method according to claim 10, further comprising a fifth step of updating said specification information stored in said predetermined storage means, based on a verification result by said fourth step.

12) A program for controlling a computer to monitor a component invocation for generating contents in a web page in which said contents are generated dynamically, wherein the program causes said computer to execute:
a first process of analyzing information on a library to be used for describing said component invocation;
a second process of replacing a definition file of said library stored in predetermined storage means, with a library definition file including a function of extracting information on said component invocation on execution of said component invocation, based on a result of the analyzing; and
a third process of executing said component invocation by using said replaced library definition file, and extracting the information on said executed component invocation.

13) The program according to claim 12, wherein if it is not determined until a run time whether a predetermined component invocation is actually executed or not, said third process causes said computer to execute a process of extracting the information on said component invocation with or without the execution of said component invocation.

14) A program for controlling a computer to support web application development, wherein the program causes said computer to function as:
means for executing a component invocation for generating contents in a web page in which said contents are generated dynamically;
means for monitoring execution of said component invocation, and extracting information on said component invocation; and
means for verifying a consistency between said component invocation and the component which is a target of said component invocation, based on the extracted information on said component invocation.

15) The program according to claim 14, wherein the means for verifying the consistency between said component invocation and said component verifies the consistency between said component invocation and said component by collating specification information in which the information on said component invocation preset for said web page and stored in predetermined storage means is packaged, and the information extracted at said monitor.

16) The program according to claim 15, wherein the program further causes said computer to function as means for updating said specification information based on a verification result by the means for verifying the consistency between said component invocation and said component.

17) A computer readable recording medium having recorded a program according of claim 12.

18) An article of manufacture comprising a computer usable medium having computer readable program code means embodied therein for causing a computer to execute a predetermined data process, the computer readable program code means in said article of manufacture comprising computer readable program code means for causing a computer to effect the steps of:
a first step of analyzing, with respect to a component invocation for generating contents in a web page in which said contents are generated dynamically, information on a library to be used for describing said component invocation;
a second step of replacing a definition file of said library stored in predetermined storage means, with a library definition file including a function of extracting information on said component invocation on execution of said component invocation, based on a result of the analyzing; and
a third step of executing said component invocation by using said replaced library definition file, and extracting the information on said executed component invocation.

19) An article of manufacture comprising a computer usable medium having computer readable program code means embodied therein for causing a computer to execute a predetermined data process, the computer readable program code means in said article of manufacture comprising computer readable program code means for causing a computer to effect a fourth step of verifying a consistency between said component invocation and the component which is a target of said component invocation, by collating specification information in which the information on said component invocation preset for said web page and stored in the predetermined storage means is packaged, and the information extracted at said third step.

20) A computer program product comprising a computer usable medium having computer readable program code means embodied therein for causing web application development, the computer readable program code means in said computer program product comprising computer readable program code means for causing a computer to effect the functions of:
a monitor for monitoring execution of a component invocation for generating contents in a web page in which said contents are generated dynamically, and extracting information on said component invocation; and
a consistency verification unit for verifying a consistency between said component invocation and the component which is a target of said component invocation, based on the information on said component invocation extracted by said monitor.

21) A computer program product as recited in claim 20, the computer readable program code means in said computer program product further comprising computer readable program code means for causing a computer to effect functions of a specification update unit for updating said specification information based on a verification result by said consistency verification unit.
